(19) United States
(12) Patent Application Publication
(10) Pub. No.: US 2003/0168399 A1
(43) Pub. Date: Sep. 11, 2003

(54) Burping filter

(76) Inventor: Mark S. Quackenbush, Winter Haven, FL (US)

Correspondence Address: Arthur L. Girard, 8310 Poplar Hollow Trail, Richmond, VA, 23235, US

(21) Appl. No.: 10/386,180

(22) Filed: Mar. 11, 2003

Related U.S. Application Data
(63) Continuation-in-part of application No. 09/867,144, filed on May 29, 2001.

(51) Int. Cl. B01D 29/00

(52) U.S. Cl. 210/488; 210/510.1

(57) ABSTRACT

According to the present invention there is provided a ceramic foam filter for molten metal filtration comprising a preferably substantially flat inlet portion, an intermediate portion and an outlet portion that incorporates an undulating surface defined by smoothly transitioned peaks and valleys. Making the outlet portion or surface irregular as described herein provides paths for entrapped air to escape or vent during start-up, thereby significantly reducing or eliminating the need for potentially harmful corrective action, such as rapping, to achieve a rapid filter star-tup.

This application is a continuation-in-part of U.S. patent application Ser. No. 09/867,144 filed May 29, 2001.

### FIELD OF THE INVENTION

The present invention relates to filters for molten metal, especially aluminum and steel, and more particularly to such a filter that initiates metal flow rapidly without the need for rapping or other operator intervention at the start of a cast.

### BACKGROUND OF THE INVENTION

In the casting of metals such as steel and aluminum, it is common practice to place a porous filter of one type or another, generally ceramic in makeup, in the metal stream downstream of the furnace and upstream of the casting apparatus. The purpose of such a filter is to remove particulate inclusions that inevitably find their way into the metal during the melting and pouring operations. Such inclusions, if left unfiltered, can result in defects in the cast metal. Such defects can and often do cause rejection of or failure in the product made from the cast metal. In the conventional practice, the filter element is placed into a cavity in a filter housing and at least loosely sealed so that metal contacting the filter must pass through the filter rather than around it in order to move downstream.

From an operations standpoint, one of the major problems with the use of such porous filters that are conventionally fabricated from friable ceramic materials is the start-up procedure that must be performed at the start of every cast when using a new filter. Such start-up requires that the filter be “primed”, i.e. metal flow therethrough be initiated so that a uniform metal flow with a minimum of disruption of the metal can be established as early as possible in the casting operation. To accomplish this metal flow initiation, air that is trapped within the pores of the filter or in the area of the bottom surface of the filter and whose escape therefrom due to the structure of the filter element housing, must be allowed or caused to escape in order that metal flow through the filter element can be initiated. This action is often referred to as “burping” the filter, i.e. removing air entrapped in the porous material of the filter or trapped below the filter element, which air will resist passage of the heavier metal until it has been removed. In many metal casting operations, it is conventional practice for the operators to attempt to accelerate the “burping” of the filter my rapping the same with a metal tool of one type or another. While this is generally effective in achieving “burping” it also runs the significant risk that small pieces of the friable filter material will be broken off of the filter body and passed downstream in the flowing metal. With this practice, the filter itself becomes a source of inclusions that adversely affect the quality of the cast metal.

U.S. Pat. No. 5,785,851 issued Jul. 28, 1998 describes a molten metal ceramic foam filter having a non-planar inlet portion, an intermediate body portion and a lower outlet portion having a substantially flat continuous outlet surface. The advantage alleged for such a structure is that the increased surface area in the inlet portion provides an enlarged area for metal filtration.

While such a structure may provide such enhanced filtration area, the flat continuous outlet surface makes “burping” difficult as has been the case with virtually all conventional prior art such filters that generally have flat both inlet and outlet surfaces. Thus, while the description of the '851 patent suggests an improved filter from the point of view of enhanced surface area at the inlet side, it does nothing to solve the “burping” problem inherent with such filters. Additionally, the presence of an irregular inlet surface as described in the '518 patent mentioned above can result in a turbulent metal flow during filter start-up or initiation thereby adding to the problem of inclusions by exposing the more of the metal to air resulting in additional oxidation products that have to be removed by the filter, thus perhaps promoting faster plugging of the filter.

### OBJECT OF THE INVENTION

It is therefore an object of the present invention to provide a porous ceramic foam filter for the filtration of molten metal that substantially reduces or eliminates the problem of filter “burping” thereby reducing or eliminating the need for filter rapping or other deleterious activity related to filter start-up.

It is another object of the present invention to provide a porous ceramic foam filter that exhibits a start-up “burping” time that is significantly reduced from that of similar prior art such devices.

### SUMMARY OF THE INVENTION

According to the present invention there is provided a ceramic foam filter for molten metal filtration that has a preferably substantially flat inlet portion, an intermediate portion and an outlet portion that incorporates an undulating surface. Making the outlet portion or surface irregular, i.e. an outlet surface defined by smoothly transitioned peaks and valleys, as described herein, provides sloped paths for entrapped air to escape or vent during start-up, thereby significantly reducing or eliminating the need for potentially harmful corrective action, such as rapping, to achieve a rapid filter start-up.

### DESCRIPTION OF THE DRAWINGS

FIG. 1 is a cross-sectional view of one embodiment of the ceramic foam filter of the present invention.

FIG. 2 is a plan view of the outlet portion surface of one embodiment of the ceramic foam filter of the present invention.

FIG. 3 is a perspective view of the outlet side or portion of an alternative embodiment of the ceramic foam filter of the present invention.

FIG. 4 is a plan view of the outlet surface of yet another alternative preferred embodiment of a ceramic foam filter element of the present invention.

FIG. 5 is a cross-sectional view of an alternative embodiment of the filter of the present invention.

### DETAILED DESCRIPTION

In the initiation of a cast of metal, the ceramic foam filter is conventionally placed in a holder or frame of one kind or another in the metal stream with gravity forming the principal driver for the flow of the metal, although pumping of the metal is practiced in certain applications. Upon the initiation of metal flow through the filter, air contained within the pores of the filter or in the area immediately below the filter is commonly trapped at the lower, outlet side of the filter often requiring filter rapping or other undesirable corrective action to initiate flow by overcoming the blocking action of the entrapped air as described above. It is the conventional regularity, i.e. the incorporation of flat areas in the lower outlet surface of such filters that makes removal of such entrapped air more difficult. Even the provision of severely transitioning lower surfaces, from flat to apertures that extend inwardly of the body of the filter at a sharp angle, for example a right angle, do not provide a path adequate to properly assist with the evacuation of entrapped air or gas. Thus, the provision of a filter lower surface that is “undulating”, i.e. has peaks and valleys that are defined by sloping or smoothly transitioned/transitioning surfaces as described herein comprises a significant contribution to the metal filtration art that allows the filter to burp efficiently upon start up of the filtering operation. Stated differently, the term “undulating” is used herein in the accordance with the classic Webster's Dictionary definition, “having a wavy look”, “having a waving curvy line or form”, i.e. exhibiting smooth transitions between peaks and valleys.

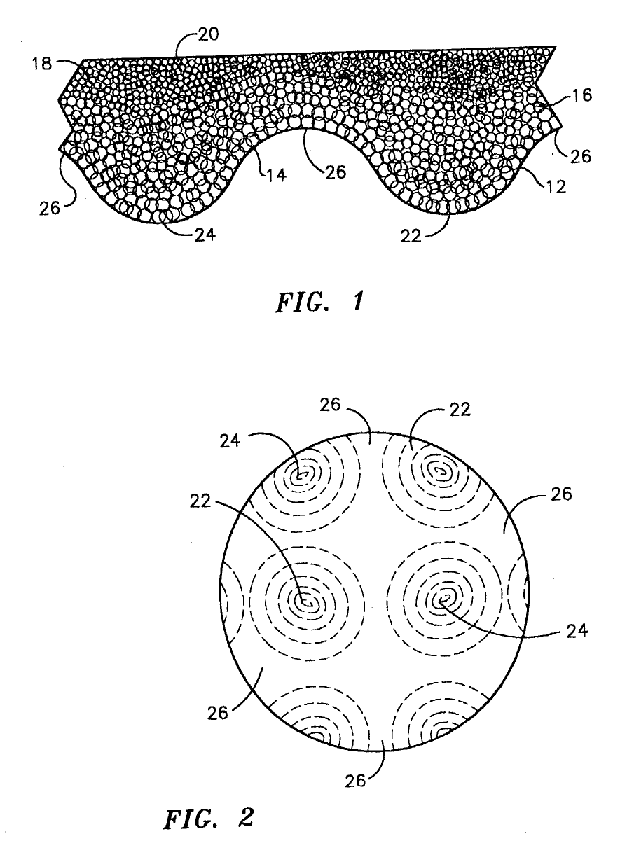

Referring now to FIG. 1, the ceramic foam filter 10 of the present invention comprises: 1) a lower outlet portion 12 with an outlet surface 14 having an irregular geometry; 2) a core or main body portion 16; and 3) preferably, but not necessarily a substantially planar inlet portion 18 having an inlet surface 20. According to one embodiment of the present invention, the upper inlet surface may also be made irregular if this is desired. The irregular geometry of outlet surface 14 can have a large variety of configurations at least some of which are described hereinafter, and it is the smoothly transitioning of the irregularity of outlet surface 14 that forms the principal subject of this application.

As used herein, the term “ceramic” is meant to include all of the commonly used such materials including, but not limited to: alumina (Al₂O₃), mullite, zirconia, silica, silicon carbide, silicon nitride, zircon, silicon oxy nitride, silicon aluminum oxy nitride, cordierite,or combinations thereof. Additionally, the term ceramic includes the foregoing materials and other similar materials to which have been added various additional materials to form the compositions from which the porous ceramic foam filters of the present invention are formed. These additional materials include, but are not limited to: 1) bonding agents such as aluminum orthophosphate, colloidal silicas, aluminas, titanias, zirconias, glasses etc; 2) sintering aids such as titania; 3) toughening additives such as alumino-silicate fibers; and 4) rheological additives such as clays, organic materials, dispersants, antifoams, green binders and wetting agents.

The key aspect of the ceramic foam filter elements of the present invention is that the outlet surface undulates allowing air trapped in the filter and below the filter to vent using the lower or “valley” areas of the outlet surface as described hereinafter to serve as chimneys. Such venting is only adequately provided in the case where the transition areas from the peaks to the valleys are smooth or gradual and not sharp or severe, for example right angles, since the latter do not provide the desired channeling of entrapped gases to permit venting thereof as described herein. Thus, any number of outlet surface configurations beyond those specifically described herein may be used so long as the outlet surface configuration is defined by smoothly transitioned peaks and valleys that provide the foregoing capability to vent trapped air during start-up.

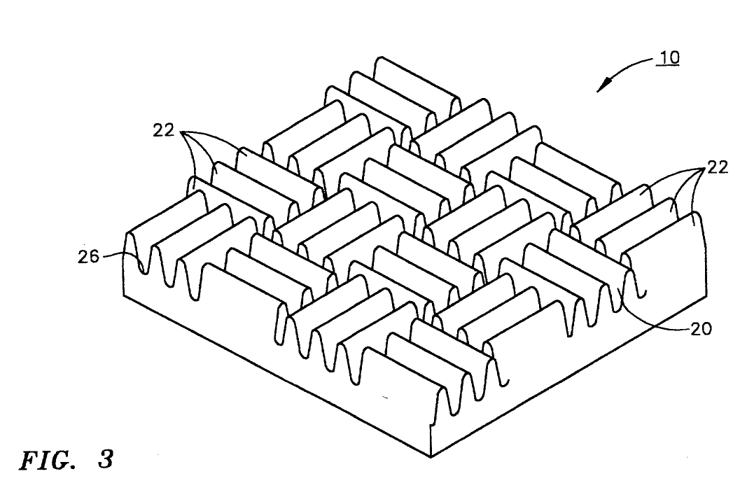

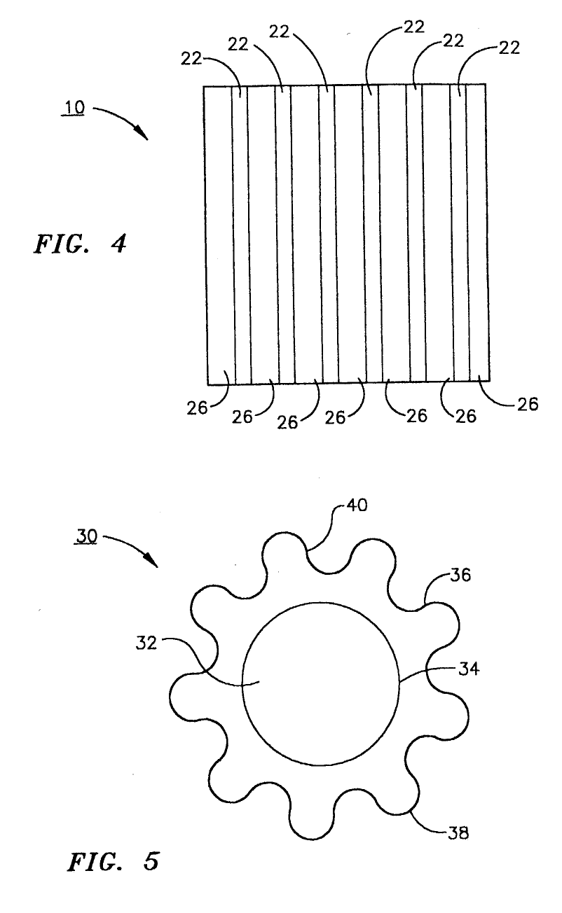

As shown in FIG. 2, which depicts one embodiment of the outlet surface of the porous ceramic foam filter of the present invention, outlet surface 14 has an “egg crate” design. According to this embodiment, outlet surface 14 has raised peaks 22 with generally coplanar top surfaces 24 and lower depressions or valleys 26 surrounding the bases of each of peaks 22. Such a surface is depicted in cross-section in FIG. 1. While the spacing of peaks 22 and valleys 26 is not of particularly critical importance, it is preferred that peaks 22 and valleys 26 be spaced apart a distance of from about 1 to about 3 inches.

While according to one of the preferred embodiments of the present invention depicted in FIG. 1, inlet surface 20 is flat, it will be obvious to the skilled artisan that inlet surface 20 may take on any number of other regular and irregular configurations so long as outlet surface 14 presents some sort of smoothly undulating structure as described herein. Thus, a wide variety of both the inlet and outlet surfaces can be imagined, designed and fabricated.

Among these are the so-called acoustic geometries conventionally used in ceiling and wall panels where the control or absorption of sound is desired. Such geometries present a repetitive pattern demonstrating a plurality of substantially parallel members with substantially parallel ridges or peaks and substantially parallel valleys or depressions between the adjacent parallel ridges or peaks and include the desired smooth transitions between peaks and valleys. The presence of such peaks and valleys, as in the case of those described above in connection with the “egg crate” configuration presented in FIG. 2, provide the advantages inherent venting capability in the outlet surfaces of the porous ceramic foam filters of the present invention.

The configuration of inlet surface 20, although preferably flat, may comprise any of the foregoing smoothly transitioned undulating structures described in connection with outlet surface 14.

As will be apparent to the skilled artisan, the porosity of the ceramic foam through the thickness of the filter, from inlet surface 20 to outlet surface 14 can be varied to provide a porosity of ever finer pore size as the metal progress from surface 20 toward surface 14. For example, the ceramic foam proximate surface 20 in inlet portion 18 could have a pore size of 30 pores per inch (ppi), intermediate portion 16 could have a pore size of 40 ppi and outlet portion 12 have a pores size of perhaps 50-65 ppi to improve metal flow and delay filter plugging.

While the ceramic foam filter of the present invention has been previously described herein as a “flat” filter element, it will be obvious to the skilled artisan that the same principles that apply to such flat filter elements and similarly applicable to round or tubular filter elements as applied in certain casting situations where metal enters the inside of a ceramic foam tube and is filtered in its exit through the wall of the ceramic foam tube. In such a situation, the undulating surface of outlet surface 14 is supplied to the outlet surface of the ceramic foam filter tube. Such an embodiment is depicted in FIG. 5 that shows a tubular ceramic foam filter element 30 having a passage 32 formed by inlet surface 34 and an undulating outlet surface 36 which, although shown as having longitudinal peaks 38 and valleys 40 could also have undulating configurations of any of the types previously described in connection with flat ceramic foam filter elements.

Similarly, in those case where a tubular ceramic foam filter element is used and metal flows from the outside of the tubular structure toward the inside thereof, an undulating surface, as described herein, would be provided on the inner surface of the tubular ceramic foam filter element to realize the advantages recited hereinabove. It will also be readily recognized that the inlet surface 34 of such a tubular element could include an irregular or undulating surface.

The manufacture of foams suitable for the formation of ceramic foam filter elements of the type described herein are generally quite well known in the art, however two possible options for such manufacture are described herein.

Firstly, the raw ceramic powders and binding agents can be dispersed in an aqueous slurry. For example, the following slurry can be formed by blending the constituents as percentages by weight: alumina, 65%, clay 1%, aluminum ortho phosphate, 25% and water, 9%. An alternative composition suitable for slurrying would be: alumina, 60%, mullite, 14%, colloidal silica, 5.8%, polyvinyl alcohol 50% solution, 3%, clay 2%, antifoam, 0.2% and water, 15%. In both cases, the components are blended to assure complete wetting of the ceramic powder thereby forming the slurry.

The foregoing ceramic slurries are then impregnated into a reticulated open cell polyurethane foam shape of the desired size and shape. The excess slurry is removed by squeezing the part. The impregnated foam is then dried at from about 100-200° C. and fired at between about 750-1700° C. During the firing process, the polyurethane foam is burnt away leaving the fired ceramic foam replica of the starting foam. Porous ceramic foam elements can be formed properly sized from such a process. Or manufactured oversized and then machined to size.

As the invention has been described, it will be apparent to those skilled in the art that the same can be varied in many ways without departing from the spirit and scope of the invention. Any and all such modifications are intended to be included within the scope of the appended claims.

What is claimed is:

1) A ceramic foam filter for the filtration of molten metal comprising:
A) an inlet portion having an inlet surface;
B) an intermediate portion; and
C) an outlet portion having an undulating outlet surface defined by smoothly transitioned peaks and valleys.

2) The ceramic foam filter of claim 1 wherein said undulating surface has an egg carton shape.

3) The ceramic foam filter of claim 1 wherein said undulating surface has an acoustic shape.

4) The ceramic foam filter of claim 1 wherein said undulating surface comprises a series of parallel ridges and valleys.

5) The ceramic foam filter of claim 1 wherein said inlet portion has a substantially flat surface.

6) The ceramic foam filter of claim 1 wherein said inlet portion has an undulating surface.

7) The ceramic foam filter of claim 6 wherein said undulating surface consists of a series of alternating peaks and valleys.

8) The ceramic foam filter of claim 6 wherein said undulating surface comprises an egg carton shape.

9) The ceramic foam filter of claim 6 wherein said undulating shape comprises an acoustic shape.

10) The ceramic foam filter of claim 1 that is a tube comprising an undulating outer periphery that is defined by smoothly transitioned peaks and valleys and serves as the outlet surface and an inner cavity defined by a smooth and continuous peripheral inlet surface.

11) The ceramic foam filter of claim 1 that is a tube comprising outer periphery that serves as the inlet surface and an inner cavity defined by an undulating peripheral outlet surface comprised of smoothly transitioned peaks and valleys.

12) The ceramic foam filter of claim 1 that is a tube comprising an undulating outer periphery that serves as the inlet surface and an inner cavity defined by an undulating peripheral outlet surface defined by smoothly transitioned peaks and valleys.

12) A ceramic foam filter for the filtration of molten metal comprising:
A) an inlet portion having a substantially flat and continuous surface;
B) an intermediate portion; and
C) an outlet portion that having an undulating surface.
